(19) United States
(12) Patent Application Publication
(10) Pub. No.: US 2002/0124245 A1
(43) Pub. Date: Sep. 5, 2002

(54) Method and apparatus for advanced software deployment

(76) Inventors: Alvin Maddux, Fremont, CA (US); Glenn Baker, Los Gatos, CA (US); Brian Donohoue, Berkeley, CA (US)

Correspondence Address: QUINE INTELLECTUAL PROPERTY LAW GROUP, P.C., P O BOX 458, ALAMEDA, CA, 94501, US

(21) Appl. No.: 09/929,832

(22) Filed: Aug. 13, 2001

Related U.S. Application Data
(60) Provisional application No. 60/225,567, filed on Aug. 14, 2000.

(51) Int. Cl. G06F 9/445; G06F 17/30

(52) U.S. Cl. 717/176; 717/177; 707/10; 709/220

(57) ABSTRACT

A method and/or system allow for deployment of complex software or operating system application using native deployment routines.

### FIELD OF THE INVENTION

The present invention is related to the field of information handling devices. More specifically, the present invention involves a methods and/or system and/or devices to allow deployment of advanced operating system software in various environments.

### BACKGROUND OF THE INVENTION

A number of prior art techniques have been proposed and developed for deployment of software applications and in particular for deployment of operating system software such as Microsoft® Windows® software. Widows NT/2000 Installations and deployment is especially difficult in environments where LAN and WAN network bandwidth and/or hardware issues exist.

Prior art options of NT/2000 deployments include:

Disk Imaging or “Cloning”`

At first glance this appears to be the fastest deployment system. However the shortcomings are numerous and may increase the work involved. A few of the most common issues are:

Installation and configuration errors are reproduced to all machines and may not be noticed until after the images are deployed.

“Image management” can quickly become complicated, due to multiple images required for diverse hardware environments. May force hardware standardization (re-investment).

Image setup is complex, and time consuming.

For upgrades, there is no rollback to the previous configuration.

User settings and data are lost during the copying process.

Post-installation configuration management is lacking.

When problems are encountered, Microsoft recommends reinstalling the application and if that does not work, manually reinstalling the operating system.

Certain applications (such as Microsoft's SMS client and Site Server) remain unsupported.

While, deploying an image is fast, there is substantial setup time and effort. As a result, in most cases, imaging may not be the fastest method, and it is not the most cost-effective method. When measuring total cost of deployment, imaging solutions may offer a lower initial cost per seat but have a higher total cost of ownership. To better understand the total cost of ownership, add the cost of building each master image plus managing, configuring, versioning and storing these images.

Manual Installation

The most common Microsoft-supported installation method, but with some disadvantages:

Labor intensive for the IT Department.

Every system is “uniquely” installed (the human factor, which significantly reduces success at standardization of software configuration management).

Installation Scripts

Another deployment option, and when used with the Microsoft unattended installation, it is a supported installation method. However, it has numerous shortcomings:

Microsoft unattended installation does not support native application installation.

Scripts are generally complex to create and maintain.

Many scripts require extensive research and trial and error periods to implement.

Some scripts require administrator and/or user interaction at the desktop to complete the installation.

Hardware Swap—Purchasing New Computers

This method eliminates hardware diversity issues. The manufacturers, VARs or resellers may currently provide installation. However, this method also has numerous shortcomings:

Very expensive.

Applications remain to be installed.

OS's are may not be installed in the manner desired (partitioning, options, software levels, etc.), resulting in complete machine re-loads.

Security IDs

Though imaging applications may be believed to work well with Windows 95 and 98, it does not follow that they will work well for Windows NT/2000 deployments. The Windows NT/2000 security model in general does not allow machines to be duplicated because each machine would then have the same Security IDs (SIDs). Systems should have unique SIDs, so that they can be recognized correctly by other systems and services on the network.

Security IDentifiers are used to secure the operating system. If the same SID is used on all machines, any user could potentially access the entire computer contents (files and registry) of any other computer without authentication. This means that a curious employee or contractor could access sensitive financial information, personnel records, or even the CEO's computer without being asked for a password. Obviously, such a situation could have disastrous results for a company.

While third party SID changers have been proposed, there are clearly several issues that make their use problematical.

SID Changing Outside of Sysprep is Not Supported by Microsoft.

Third-party SID changers are not supported by Microsoft. Most third-party SID changers do not conform to the same parameters that Microsoft uses to generate SIDs.

Microsoft Support

If application or operating system issues were to arise, Microsoft would suggest reinstalling the operating system and/or application in order to reproduce the problem. If it turned out that disk duplication was the cause, an installing could have to reinstall the system all over again. Typically, Microsoft gives only a best effort support on this and future problems.

Authentication

Certain programs (such as third-party clients, databases, and security systems) make use of the SID for authentication. Changing the SID might interfere with normal operations, and it may not be discovered until a rollout is well under way. It is likely that vendors would also instruct to reinstall the operating system according to the manufacturer's instructions, when they are called for support.

Thoroughness

SID changers may not thoroughly change the SID at every location where it resides in the operating system, registry, file system, profiles and applications.

Future Developments

It appears that future Microsoft service packs, option packs, and operating system revisions will make further use of SIDs. If SID changers fail in some respect, systems may not work with new software.

Microsoft acknowledges that cloning/imaging is an installation option, but to be effective they recommend that customers use their Sysprep tool in support of these applications (but is not recommended on servers). In the case of installing Site Server, Microsoft recommends against using cloning software because some of the Site Server components install computer-specific information that cannot be cloned.

To install the basic windows NT/2000 operating system, the Microsoft unattended setup and RIS/Sysprep are the only supported tool. Several methods exist for the unattended setup deployment and your requirements and environment will determine the exact method. Most IS departments wish to spend as little time at the desktop as possible, and have fallback positions in case problems arise.

### SUMMARY

In contrast, the present invention in specific embodiments involves methods and software components that provide rapid, consistent and low-cost deployments of Windows NT/2000 and operating systems with similar issues, offering numerous advantages in specific embodiments over other upgrading solutions, including:

Microsoft or other native installation methods are used for deployment of the operating system. This provides consistent and uniform installations, regardless of hardware differences, thus increasing integration quality and enterprise software-configuration management.

Installs both servers and workstations, tailoring the setup for any configuration desired (partitioning, options, software levels, etc.).

Works in a hardware diverse environment, therefore eliminating need to repurchase standard hardware configurations.

Distribution media is kept to a minimum through adaptive compression and redundancy-elimination technologies.

Upgrades with rollback are possible because previous configuration files are not wiped from the disk.

Automated process, therefore non-technical personnel can perform installations, reducing costs.

Integrates with third party Electronic Software Distribution (ESD) products.

Rollback is a safety measure that allows the IT staff to “roll” back to the last configured state of an individual machine during an upgrade. For example, if an upgrade were interrupted for an unexpected reason, a rollback feature allows an upgrader to fall back to the previous operating system and all applications and settings so that there is no downtime for that machine. Not all applications have this feature, for example imaging/cloning applications must wipe a disk clean before replacing the operating system, thus eliminating the ability to perform a rollback.

In a further embodiment, the invention involves a web-based automated deployment application (Deployment Master™) for Windows 2000 that natively installs Windows® NT/2000 on workstations and servers from a web based console that can be run from PC's and/or hand held Windows® CE devices, and can perform upgrades with the ability to “rollback” to the previous operating system configuration.

As used herein, and in the claims, systems and method discussed in terms of operating system installation may also be utilized for operating system upgrades, as will be understood in the art, and unless the context requires otherwise.

In a further embodiment, the invention can natively install the Windows® operating system on both workstations and servers via a multi-language, multi-user web based console that allows deployments to be managed via any intranet/internet connection, including hand held Windows® CE devices. In a specific example, operating systems that can be installed or upgraded include:

Windows® 2000 Server, Advanced Server, and Terminal Server, localized and Multilanguage versions.

Windows® 2000 Professional, localized and Multilanguage versions.

NT® Server, NT® Enterprise Edition, NT® Terminal Server, and NT® Workstation localized versions.

In a further embodiment, a system according to the invention features an N-Tier DNA architecture, (herein at times referred to as Deployment Master™ or DM) that can be scaled to any system configuration, and utilized as either a standalone application or as an extensible Software Development Kit.

The invention utilizes the native installation method, a preference that was developed from practical experience.

In a further embodiment, in addition to deploying operating system software, the invention automates the setup process with a feature that automatically scans all target machines to inventory the hardware on each. Then, the invention compares the inventory to a Hardware Compatibility List and reports the status of each target machine.

In a further embodiment, the invention is designed to work with Electronic Software Distribution applications and support integration with ESD packages. ESD Support provides a generic interface for integration with electronic software distribution systems, permitting installation or launch of ESD clients during the deployment process. In this way, the user can add complex application deployment and maintenance functionality only found in ESD products to the deployment process.

In a further embodiment, the invention simplifies Active Directory Migration by supporting deployment of mixed mode Windows® 2000 Domain Controllers, including optimized partition support and Domain Naming Services.

The N-tier Microsoft®DNA architecture allows it to be distributed on a single server or on multiple servers across a network in the way that best compliments those requirements. DM can cost effectively support from five to hundreds of thousands of PCs by adding DM servers to tiers that require scalability to meet enterprise deployment requirements.

Promoting the best practice of corporate software configuration management (SCM), in a further embodiment, a Configuration Management tool let's a user define and implement custom SCM templates. Companies can standardize enterprise OS configurations for servers and workstations by defining SCM templates that customize core NT/2000 components and updates, including incremental and differential combinations of back office applications, service packs and core dependencies.

In a further embodiment, a graphical interface for adding and managing Deployment Master™ hardware support for new drivers and hardware has been included. The Visual INF Manager simplifies changing adding or deleting device drivers, and can be used to resolve scanning conflicts.

Using the teachings provided herein, it will be understood by those of skill in the art, that the methods and apparatus of the present invention could be advantageously used in other situations requiring deployment of complex software applications in an operating system other than those specifically mentioned here, but with similar requirements or characteristics. The invention will be better understood with reference to the following drawings and detailed descriptions.

It is well known in the art that logic systems can include a wide variety of different components and different functions in a modular fashion. Different embodiments of the invention may can include different combinations of actions or elements. Furthermore, elements or actions that may be described below as being sub-elements of other elements, may be differently grouped in various specific embodiments. It will be clear from the teachings herein to those of skill in the art that in specific embodiments, some action steps may be preformed in different order from the examples presented herein.

For purposes of clarity, the invention is described in terms of systems that include many different innovative components and innovative combinations of components. No inference should be taken to limit the invention to combinations containing all of the innovative components listed in any illustrative embodiment.

All publications, patents, and patent applications cited herein are hereby incorporated by reference in their entirety for all purposes.

### BRIEF DESCRIPTION OF THE DRAWINGS

FIG. 1 is a block diagram illustrating an example system architecture according to specific embodiments of the invention.

FIG. 2 is a block diagram illustrating an example system according to further specific embodiments of the invention.

Other figures illustrate screen shots of an example system that embodies various aspects of specific embodiments of the current invention.

FIG. 3 is a block diagram showing a representative example information appliance in which the present invention may be embodied.

### DESCRIPTION OF SPECIFIC EMBODIMENTS

In order to facilitate description, the following discussion will describe the present invention in terms of deployment of specific operating system software (in particular, WindowsNT and Windows2000 software suites). It will be understood to those of skill in the art, however, from the teachings provided herein that the invention also may be used to deploy or update other operating system software and/or application software. The invention should therefore not be taken as limited except as provided in the attached claims.

System Overview

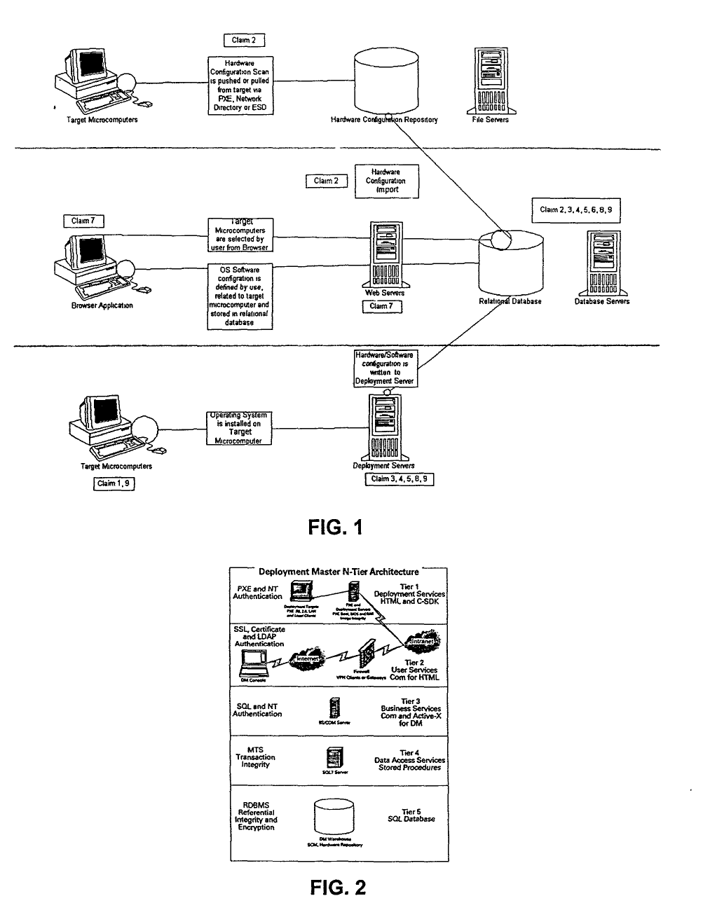

FIG. 1 is a block diagram illustrating an example system architecture according to specific embodiments of the invention.

As shown in FIG. 1, an example system architecture includes target computers, a configuration repository, a relational database, database servers a deployment server, and other elements.

The present invention is herein described in terms of general methods and devices. The general description is believed to be a full and complete description sufficient to allow an ordinary practitioner in the art to make and use the invention. It will be understood to those of skill in the art from the teachings provided herein that the described invention can be implemented in a wide variety of specific programming environments and logical systems (such as UNIX, Windows, Solaris, Oracle, etc.) using a wide variety of programming languages (such as SQL, Visual Basic, Pascal, C++, Basic, Java, etc.) and wide variety of file formats.

Additionally are descriptions of example systems and methods that embody various aspects of the present invention. These details are included, in part, in order to disclose particularly preferred modes presently contemplated for practicing the invention. It is intended, however, that the previous discussion and the claims not be limited by examples provided herein. It is further intended that the attached claims be read broadly in light of the teachings provided herein. Where specific examples are described in detail, no inference should be drawn to exclude other examples known in the are or to exclude examples described or mentioned briefly from the broad description of the invention or the language of the claims. It is therefore intended that the invention not be limited except as provided in the attached claims and equivalents thereof.

Feature Set According to Specific Embodiments

Basic Version

Install Windows 2000 Server, 2000 Advanced Server, NT Server, and NT Enterprise Edition natively.

Install Windows 2000 Professional and NT Workstation natively.

Install Windows 2000 Terminal Server.

Install SQL Server 7.0, and SQL Server client

The ability to integrate with ESD packages (i.e. Lanovation, etc.)

A proprietary SQL database, containing libraries for Installation history, hardware compatibility, installed licenses and used for detection of hardware.

File and Registry Security

Installation of Microsoft's Site Server, and Site Server Commerce Edition.

Installation of Microsoft applications, natively, such as: Office 97; Outlook 98; Back Office 4.5; Internet Explorer; SNA Client; Intellimouse; Option Pack; Starts Here training

Installation of Adobe Acrobat, Visio Enterprise, and Attachmate Extra Personal Client

File and Registry Security—via installation of Trusted Systems Services SuperCACLS

Installation via Multicast

Preboot Execution Environment (PXE)—as an option for customer

Ability to select language preference.

Microsoft® Management Console enabled—allows Deployment Master to be utilized as a snap-in

Integrated with Microsoft's Systems Management Server.

Scheduled Deployments

Web Interface

Advanced Version

RET Services—Redundancy Elimination Technology

Remote Wakeup on LAN

Installation Rollback—from upgrade process.

Installation Verification

Report on Licensing

DMI Console

### Installation Requirements and Specific Components

Deployment Master (DM) Servers

Standalone DM Server

A standalone DM server requires a dedicated application server platform capable of supporting Windows 2000 server, MS SQL7, IIS 5.0 and heavy file I/O concurrently.

Distributed DM Installation Server

A DM installation server provides the Windows source tree to the deployment targets. A Distributed tier 1 implementation of DM is a common scenario since it is the tier that requires the most server resources and network bandwidth. Typically a distributed Tier 1 implementation involves installation of dedicated DM Installation Servers or leveraging existing NOS infrastructure by identifying departmental file servers with adequate storage, processor and network controller hardware. Typically, a departmental file server meets or exceeds performance requirements for heavy file I/O required by deployments. QOS control can be installed to for daytime deployments to ensure controlled network bandwidth and file server utilization.

Distributed DM Web Server

A DM web server provides the web browser access to the DM Console. Logically, this is Tier 2 and 3 of the DM DNA architecture. A Distributed tier 1 implementation of DM is less a common scenario since it is not a tier that requires intensive server resources and network bandwidth. Typically a distributed dm web server is implemented to provide support for a large number of concurrent DM Console sessions. DM web server implementation requires IIS 4.0 or better and involves installation of dedicated DM WEB Servers or leveraging existing NOS infrastructure by identifying local or remote IIS servers with adequate storage, processor and network controller hardware. Typically, a local or remote intranet IIS server meets or exceeds performance requirements for DM user and business services processing.

Distributed DM SOL Server

A DM SQL server provides the data access services for IIS and also serves as a central configuration repository. Logically, DM SQL server provides tier 4 and 5 of the DM DNA architecture. Distribution of tier 4 or 5 is the least common scenario since the type and size of DM SQL transactions are quite small. Scaling the DM SQL server tier usually occurs when a large IT organization wishes to maintain a central configuration repository in environments that have Island networks or the need to transit low-bandwidth WAN links.

Deployment Media

In general, every deployment requires at least one media. Choose the appropriate media to fit your deployment requirements. Depending on the type and scale of your deployment, various combinations of boot devices and deployment share points will be used.

Thus, it will be seen that Deployment Master is an automated, unattended solution to deploy Windows NT/2000 natively. Designed from a System Administrators perspective, Deployment Master delivers a new level of service that is unmatched by any other deployment tool on the market today. The result is a tool that automates all phases of a deployment—not just the distribution of the operating system. Before installing the operating system, Deployment Master scans the hardware of target machines, automatically comparing the results to Microsoft's Hardware Compatibility List. Then a report is produced to detail any incompatibilities that it finds. Once hardware compatibilities are assured, Deployment Master then guides you through the deployment process. After the initial installation, Deployment Master can be used for ongoing upgrade projects, new PC rollouts, or rebuilding workstations/servers that have become corrupted or misconfigured.

Deployment Master's Console is Web based, allowing you to deploy from anywhere. Because Deployment Master's central console is web based, the deployment can be securely managed from anywhere that you have internet/intranet access. Perform operating system builds on multiple target machines simultaneously from a multi-user Web based central console.

Deployment Master features a state of the art N-tier Microsoft DNA architecture, DM can be distributed on a single server or on multiple servers across your network in the way that best compliments your deployment requirements. This means DM can cost effectively support from five to hundreds of thousands of PCs by adding DM servers on the tiers that need to be scaled for your deployment requirements.

How Deployment Master is Different From Other Deployment Applications

Secure, Web based Deployment Console. Deployments can be performed from anywhere that has internet/intranet access. Security is full SSL certificate based 128-bit authentication, and sessions can be encrypted.

Native, in-place installations—and upgrades with rollback.

Deploys to both PC's and Servers.

Automated hardware and software scanning, inventorying, and compliance verification with Microsoft's Hardware Compatibility List.

Easily manages deployment environments with diverse hardware.

Scalable, N-Tier architecture.

Preboot Execution Environment (PXE) technology.

Standards based, open architecture with SDK's for all application tiers.

Installs either an NT/2000 server or NT/2000 Workstation/Professional from the same CD or network source.

Third party Electronic Software Deployment support.

Manages multiple software installation methods.

Supports installation in multiple languages, such as English, French or German.

Supports advanced file and registry security and auditing configurations.

Deployment Master is a file based installation application, not an imaging or cloning application. The advantages includes:

Eliminate the risk of deploying corrupt files. Potential conflicts or errors are detected and resolved before you deploy.

Upgrades can be performed without wiping the previous operating system from the target machine, thus providing a rollback option.

Hardware diversity—There is no need to standardize your hardware before deploying Windows NT/2000.

Deploy Microsoft products that cannot be deployed with imaging applications (Site Server, for example).

The Deployment Master Process:

Hardware/Software Scan

Deployment Master automatically scans all target workstations/servers to detect and inventory all hardware/software on those machines.

This inventory list is then automatically compared to the Microsoft Hardware Compatibility List.

A report is produced to detail the compatibility of each target workstation/server.

Deployment process

Deployment Master can take control of the target machine before an operating system is installed with a graphical, programmable pre-boot operating system.

Deployment parameters for target workstations/servers are entered via Deployment Console.

Templates can be utilized for groups of target machines.

Deployment Console is run from a web browser, so it is platform independent.

Personalized settings for each machine can be configured if desired.

Deployment can be Multicasted to targets to build multiple workstations/servers simultaneously.

Operating System builds occur on unattended workstations/servers, either as a first time build or as an upgrade.

Easily integrated to third party Electronic Software Distribution applications.

Security

Deployment Master's Web console is protected by SSL and/or certificate based 128-bit authentication.

Sessions can be encrypted.

Post-Deployment

Deployment Master can be utilized for ongoing upgrades, as necessary.

New PC rollouts as the company grows and expands.

Re-deployments due to company re-structuring.

Re-build workstations/servers that have become corrupted or misconfigured.

Results

Deployment success rate is extremely high because the process complies with Microsoft's installation procedures.

Improved management of the deployment process

Increased accuracy and consistency of the deployment

Efficiently manage more workstations/servers with fewer people

Increased IT Quality of Service to end-users

Reduced Total Cost of Ownership

Further Features of Specific Embodiments

Installs Windows 2000 Server, 2000 Advanced Server, in localized and Multilanguage versions.

Installs Windows 2000 Professional, in localized and Multilanguage versions.

Installs NT Server, NT Enterprise Edition, NT Terminal Server, and NT Workstation natively.

Installs Windows 2000 Terminal Server.

Installs SQL Server 7.0, and SQL Server client

The ability to integrate with Electronic Software Distribution packages

Programmable SQL database, containing libraries for Installation history, hardware compatibility, installed licenses and used for detection of hardware.

File and Registry Security

Robust personality migration for workstations

Installation of Microsoft's Site Server, and Site Server Commerce Edition.

Installation of Microsoft applications, natively:

Back Office

Internet Explorer

Option Pack

Installation via Multicast from PXE.

Quality Of Service (QOS) bandwidth control for both multicast and non-multicast installations

Preboot Execution Environment (PXE).

Ability to select language preference.

Complimentary to Microsoft's Systems Management Server tools and solutions

Scheduled Deployments

N-Tier DNA Web Interface

System wide comprehensive referential data integrity for security, efficiency and performance.

Other Benfits

A benefit that Deployment Master automation brings to the project is efficiency through all phases of the deployment—repetitious tasks do not need to be performed by the people tasked with deploying the applications. Several cost savings are immediately realized:

Multiply the effectiveness of existing IT staff, they can focus on other tasks during the deployment process.

Reduced error correction due to the reduction of “human factor” errors.

The deployment can be accomplished more efficiently via Multicasting technology.

PXE and Wakeup-on-LAN technologies allow access to all machines on the network.

Web based Deployment Console provides centralized control of the deployment from any location.

As noted earlier, DM can automate the entire deployment process.

Automated power-on of all machines on network, including those new machines without operating systems

Automated scan of target machines of all hardware for compliance with Microsoft's Hardware Compatibility List

Group profiles can be automatically configured for departmental settings.

Automated deployment of Windows 2000

After the initial installation, Deployment Master can be used for ongoing upgrade projects, new PC rollouts, or rebuilding workstations/servers that have become corrupted or misconfigured.

### Examples of Specific Aspects of the Invention According to Specific Embodiments

The list below, in outline format, describes in greater detail, various aspects of a system according to the present invention.

1. DM Script Engine resides at the target machine and executes a batch input created from a relational database data export, and according to specific embodiments performs as follows:

a. Using an executable program, script or XML message parser to read input parameters defined as name value pairs generated by a client server database application for the purpose of executing instructions that cause the installation or upgrade of an operating system; where said name/value pairs may be customized by a user through a browser or client application interface.

b. During or after operating system installation/upgrade, initiates installation of client or server software applications using native installers (push) and/or by installation of an ESD (Electronic Software Distribution) client agent that enables push or pull client or server software application installations customized for a specific OS installation. The invention provides an open architecture enabling you to embed any ESP in the process.

c. Before and after operating system installation/upgrade initiates capture and or restoration of machine and/or user specific data such as operating system configuration files, desktop icons for the purpose of migration rollback or recovery of an operating system.

d. Changing, adding or deleting disk partitions based on parameters passed from a relational database

e. Optionally installing specific drivers for specific hardware based on parameters passed from a relational database

f. Connecting to a specific operating system installation source based on parameters passed from a relational database

g. Downloading specific elements of an operating system installation source tree based on parameters passed from a relational database.

h. DM SE could also be an XML parser on the machine.

2. DM Scans collects detailed hardware configurations that are loaded in a relational database for the purpose of relating hardware configurations to operating system software configurations to determine which, if any, hardware is compatible with versions and configurations of an operating system.

a. Scanning PCI, PnP, SMB, DMI, USB, PCMCIA, CardBus, IEEE 1394, ATA, SCSI and Video bios registers for the purpose of creating a machine specific hardware configuration in a structured file such as xml message, tab delimited or csv that can be bulk copied or read natively by a relational database for processing and output.

b. Expose and dump the entire PCI, PnP, SMB, DMI, USB, PCMCIA, CardBus, IEEE 1394, ATA, SCSI and video bios registers with 16 bit utilities for DOS, DOSUNDI PXE, or PXE virtual machine scans and 32 or 64 bit utilities for Microsoft operating system scans.

c. Parse and interpret registers then format output as an xml message or structured ascii file that can be natively bulk copied by a relational database.

d. Specifically retrieving vendor id, product id, product description, subsystem id and subsystem class for use as data keys in a relational database. Generally, as known in the art, device drivers are dependent on IEEE and ANSI specification. Microsoft Plug-n-Play (PnP) does this in part. People do that to load drivers, not to load operating systems. User choses a machine which is then tagged to the software configuration.

3. Visual Driver Manager passes hardware peripheral, component and ASIC specific information to a script engine from a database for the purpose of generating a specific operating system configuration that will install a specific set of drivers specific to the target machine's hardware configuration at the time the OS installation occurs.

a. Adding driver support to the OS source tree involves parsing the third party driver OS information files to identify the binaries, installation definitions and adding them to an operating system source tree by optionally editing the original installation file and merging it with the source tree in such a way as to enable the operating systems hardware detection facility to install the device by automatic detection or by explicitly defining the hardware in an information file that the operating system reads during OS installation.

b. Specifically retrieving vendor id, product id, product description, subsystem id and subsystem class for use as data keys in a relational database. The data keys are used as parameters for Boolean installation flags for each system component requiring direct, version specific, hardware driver support by the OEM.

4. Visual OS Manager provides custom generation of Operating System installation source trees that consolidate redundant files and identifies version and language unique files. This permits multiple versions, languages and licensing models of an operating system to be installed from a single, unified source tree.

a. Retrieve CD-ROM volume & SN and create DB records of OS version, type & language. This will be a form that the user completes that is posted to the OS_tree table.

b. The primary key in this table will be the PID read from CD file \i386\setupp.ini. W2K may have an additional data field to be concatenated with the PID to form a unique identifier.

c. Language, OS version, OS service pack level, security level and release date is to be determined from the CD file \i386\prodspec.ini. The date information in \i386\prodspec.ini can be incorrect. The release date is determined by reading the date/time of this file. NT4 Enterprise edition requires the additional search for an enterprise edition file (\i386\nhloader.exe) to properly identify the OS.

d. Advanced feature: For OS versions with ambiguous description files (i.e. MSDN Chinese), a file version sample will need to be obtained. Typically the language description in such files as schannel.dll, usetup.exe and regedit.exe (from I386 directory) will give a clear indication of which OS language is truly present. The resource kit has a console utility FileVer.Exe that will give the language details in verbose mode. The developer libraries have details on the specific calls required to obtain this information natively.

e. Select boxes will be available to enable end user to override detected Operating System and Language. The user is not to have the ability to enter new operating systems or languages, but only to select from the drop down list.

f. Small Business Server edition prior to version 2000 and any non-OS CD-ROMs are to be rejected with a message to the end user. Examples are OS service packs, NT option pack and Internet Explorer CD-ROMs.

g. Get Directory & file list from CD. This list will be based on a dir filter of only the 1386 directory and the following subdirectories.

h. Launch Copy process to store I386 tree of CD-ROM onto user selected Root path. Directly below CD-ROM root path a directory is to be created and named by the CD-ROMs PID.

i. Generate CRC from list and store results in flat file of csv format. CRC source code in VB 6 necessary.

j. DTS csv formatted CRC file into OS_CRC table that is FK child of OS_tree parent table. Row that was previously create in an NTEXT column.

k. User will be prompted to select the appropriate Operating system license model.

l. Users should be able to delete uploaded CD-ROMs (See Appendix A)

m. Users should be prompted if attempt to upload same CD-ROM more than once.

n. Each Operating system will be assigned a unique ID code. This code will be used to determine the OS combinations.

o. Load each of the text files as lists

p. Generate list files for

1. General rules: Filenames and CRCs must be identical (date/time/size does not matter) to be considered a match. Process at main subdirectory level (e.g. i386 only, winntupg+subdirectories, lang+subdirectories, etc.) Output plain text file with each filename and path based on user selected root directory on a single line.

2. Each Operating system will have

1. Output list (and RAR archive) file names will have the following format:

2. character language code

3. digit Operating System combination code (pad with zeros if necessary)

4. character License model

5. digit (hex) Tree Location specification

q. Examples:

1. EN001O1.1st=English Windows NT4 Workstation, OEM license model, I386 directory.

2. FR017R3.1st=French Windows NT4 workstation and (French) Windows 2000 Professional, Retail license, System32 directory.

r. List generation based on identical and unique CRC values will be a stored procedure (run from the database).

5. Visual Package Manager moves a native or ESD repacked software application installation package from a source file system to an operating system installation source tree for the purpose of pushing a native or ESD installation package to a target during os installation.

a. Generic “forms” in the front end and tables in the database that permit a user to enter the name, source path and installation parameters of a software installation package or ESD client.

b. The OS and ESD configuration is written to parameter files for the purpose of passing the OS configuration and the “ESD packages” to be installed on the target machine are to the script engine which will then copy a custom “set” of packages per installation.

c. Deployment Agent provides multi-cast publishing services to multi-cast client subscribers. The agent interacts with the database for authentication of subscribers and configuration of file sets of subscriber sessions.

d. During OS installation, a “multi-cast” client is installed and optionally executed on the target pc that “reads” the installation parameter file and subscribes to a file based multi-cast session after the operating system is running in GUI mode and has authenticated to the Deployment Agent.

6. Deployment Database is a relational database which contains hardware and software configuration attributes specifically related for the purpose of generating operating system configuration parameters as xml messages or structured ascii text output files that can be interpreted by element 1 for the purpose of repeatable, custom operating system installations.

a. Create database tables to represent entities described in elements 1-4

b. Create database tables to represent the parameters and values of an operating systems installation facility to include elements of an operating system source tree required to perform an installation of a specific language, version, and license model.

c. Create database tables to represent operating system and application license keys per configuration.

d. Relate one or many hardware configurations to one or many operating system configurations

e. Relate processes a-c to customers by demographics and network directories so that elements a-c can be selected using customers, sites, departments and networks as operating system configuration selection criterion

f. Create a data import facility to import files created in element 2

g. Create an ETL facility to verify (apply business rules) and insert data in process a

h. Create a data export facility to export parameter files or messages for element 1

i. See DM database diagrams for detail

7. DM Web Browser A client/server application with a browser based GUI that permits a user to select microcomputer(s) and apply an operating system configuration ad-hoc or previously defined as a software configuration template.

a. Create a secure client interface that accesses a database for the purpose of providing a simple to use interface that enables a non-technical user to create complex, repeatable operating system configurations for deployment to target machines.

b. Create an administrative console that allows a network administrator to demographically model the deployment database to resemble the domain or directory objects. This includes customers, sites, departments and deployment servers.

c. Create an interface that allows ASP and customers to collaborate on deployment projects.

d. Use HTTPS security to enable secure internet deployment.

e. Create user id deployment roles that constrain user privileges by demograhics and administrative capabilities.

f. Create a hardware configuration form that allows a user to view the target machines hardware configuration, OS compatibility and optionally choose what components are to have drivers support installed.

g. Create a hardware configuration form that allows a user to designate a machine or components of a machine as compatible with a specific OS version and patch level.

h. Create a software configuration form that allows a user to define and choose and configure an operating system installation by language, license model, version and patch level.

i. Create a software and system configuration management form that allows a user to generically define packages or utilities to be pushed to a target machine during operating system installation.

j. Create a form that permits users to move machines between customers, sites and departments to reflect physical moves.

k. Create a multi-language browser translation facility that permits users to view the application in their preferred language.

l. Implement the browser application as an N-Tier DNA application.

8. Deployment Manager an agent service that packages operating system configuration files and operating system files and executables for launching a specific deployment type and media. Tracks deployment states using store and forward messaging to indicate operating system installation progress milestones.

a. PXE delivers and executes operating system deployments using a pre-boot execution environment for specific target machines by identifying hardware elements which represent data keys for parameter files delivered to a PXE server by a service agent.

b. 16 bit OS delivers and executes operating system deployments using a 16 bit operating system client for specific target machines by identifying hardware elements which represent data keys for parameter files delivered to a bootable media by a service agent.

c. 32 bit OS delivers and executes operating system deployments using a 32 bit operating system client for specific target machines by identifying hardware elements which represent data keys for parameter files delivered to a bootable media by a service agent.

d. 64 bit OS delivers and executes operating system deployments using a 64 bit operating system client for specific target machines by identifying hardware elements which represent data keys for parameter files delivered to a bootable media by a service agent.

e. Wake On Lan triggers operating system deployments using a wake on lan calls for specific target machines by identifying hardware elements which represent data keys for parameter scripts delivered to a bootable media by a service agent.

f. Scheduling cron-like facility that submits deployment configurations to a, c and f based on user defined calendar.

9. Deployment Rollback Triggered during an operating system upgrade and uses a 16 bit operating system client executed by PXE or floppy to restore operating system files required to successfully “restore” the 16, 32 or 64 bit operating system that existed prior to installation of Windows 2000.

a. Verify disk and partition space meet rollback requirements for each target PC.

b. Backup the system root directory of the operating system targeted for upgrade storing the files on a local or network file system. Log the operation.

c. Backup the registry of the operating system targeted for upgrade storing the files on a local or network file system. Log the operation.

d. Backup the I386 directory (if present) of the operating system targeted for upgrade storing the files on a local or network file system

e. Backup the DM install directory (if present) of the operating system targeted for upgrade storing the files on a local or network file system. Log the operation.

f. Backup the Windows OS directory of the operating system targeted for upgrade storing the files on a local or network file system. Log the operation.

g. Backup the MBR, boot sector and file allocation tables of the of the operating system targeted for upgrade storing the files on a local or network file system. Log the operation.

h. Restore the Windows OS directory of the operating system targeted for upgrade reading the specific target's files from a local or network file system. Log the operation.

i. Restore the registry of the operating system targeted for upgrade reading the specific target's files from a local or network file system. Log the operation.

j. Restore the system root directory of the operating system targeted for upgrade reading the specific target's files from a local or network file system. Log the operation.

k. Restore the I386 directory (if present) of the operating system targeted for upgrade reading the specific target's storing the files on a local or network file system. Log the operation.

l. Restore the DM install directory (if present) of the operating system targeted for upgrade reading specific target's files from a local or network file system. Log the operation.

Embodiment in a Programmed Information Appliance

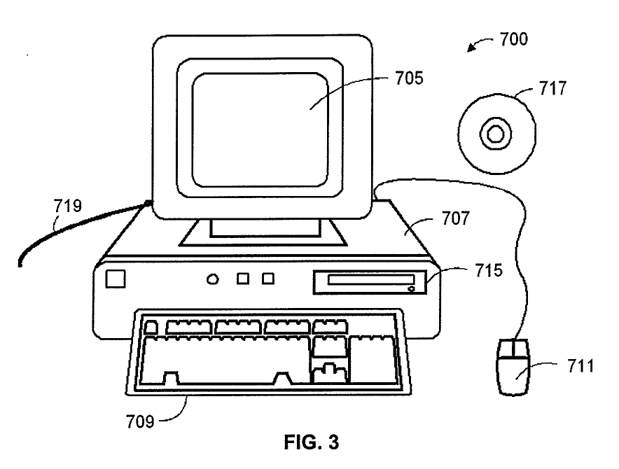

FIG. 3 is a block diagram showing a representative example information appliance in which the present invention may be embodied. Various aspects of the invention can be implemented in hardware and/or software. In some embodiments of the invention, different aspects of the invention can be implemented in either client-side logic or a server-side logic. As will be understood in the art, the invention or components thereof may be embodied in a fixed media (and/or transmissible) program component containing logic instructions and/or data that when loaded into an appropriately configured computing device cause that device to perform according to the invention.

FIG. 3 shows an information appliance (or digital device) 700 that may be understood as a logical apparatus that can read instructions from media 717 and/or network port 719. Apparatus 700 can thereafter use those instructions to direct server or client logic, as understood in the art, to embody aspects of the invention. One type of logical apparatus that may embody the invention is a computer system as illustrated in 700, containing CPU 707, optional input devices 709 and 711, disk drives 715 and optional monitor 705. Fixed media 717 may be used to program such a system and may represent a disk-type optical or magnetic media, magnetic tape, solid state memory, etc. The invention may be embodied in whole or in part as software recorded on this fixed media. Communication port 719 may also be used to initially receive instructions that are used to program such a system and may represent any type of communication connection.

The invention also may be embodied in whole or in part within the circuitry of an application specific integrated circuit (ASIC) or a programmable logic device (PLD). In such a case, the invention may be embodied in a computer understandable descriptor language which may be used to create an ASIC or PLD that operates as herein described.

Other Embodiments

The invention has now been described with reference to specific embodiments. Other embodiments will be apparent to those of skill in the art. In particular, a user digital information appliance has generally been illustrated or described as a personal computer. However, the digital computing device is meant to be any device for handling information could include such devices as a digitally enabled television, cell phone, personal digital assistant, etc.

Furthermore, while the invention has in some instances been described in terms of client/server application environments, this is not intended to limit the invention to only those logic environments described as client/server. As used herein, “client” is intended to be understood broadly to comprise any logic used to access data from a separable system and “server” is intended to be understood broadly to comprise any logic used to provide data to a separable system.

It is understood that the examples and embodiments described herein are for illustrative purposes only and that various modifications or changes in light thereof will be suggested by the teachings herein to persons skilled in the art and are to be included within the spirit and purview of this application and scope of the claims. All publications, patents, and patent applications cited herein are hereby incorporated by reference in their entirety for all purposes.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed:

1. A method of deploying software across an enterprise comprising:
registering a set of users of an enterprise:
at a deployment master workstation, receiving an administrator request to scan registered users to determine users requiring a deployment;
receiving from a process running in said user machines data indicating configuration status;
at said user machines, initiating a native setup application, with execution parameters received from said deployment master;
at said user machines, confirming said deployment.

2. The method of claim 1 further comprising;
at one or more user machines executing a configuration detection application that outputs a structured file that is easily imported into a remote database.

3. The method of claim 1 wherein said application gathers configuration parameters and parses and output said parameters in a form that can be accessed by a central database.

4. The method of claim 3 wherein said parameters comprise values of BIOS/PCI, PnP, or other registers.

5. The method of claim 3 wherein said output comprises a structured ASCII file that can be natively input by a bulk database.

6. A method of deploying software across an enterprise comprising:
a one-time application that runs and collects configuration data into a flat file anywhere or in a logon server;
to database;
administrator picks a software configuration for a machine, engine generates a parameter file. database generates a receiving from agents installed in said user machines data indicating configuration status;
at said user machines, initiating a native setup application, with user inputs received from said deployment master;
at said user machines, confirming said deployment.

7. The method of claim 1 wherein said software comprises:
a WindowsNT operating system.

8. The method of claim 1 wherein said software comprises:
a Windows2000 operating system.

9. The method of claim 1 wherein said software comprises:
a Windows operating system subsequent to Windows2000.

10. The method of claim 1 wherein said deployment integrates with Electronic Software Distribution (ESD) packages.

11. The method of claim 1 further comprising:
storing deployment history in a database.

12. The method of claim 1 wherein said deployment may proceed via Multicast from a Preboot Execution Environment (PXE).

13. The method of claim 1 further comprising controlling bandwidth over a deployment media by:
measuring bandwidth capacity over a deployment path;
calculating total data transfer for a particular deployment session;
controlling deployment transfer bandwidth to minimize QoS degradation while meeting maximum allowed deployment latency.

14. The method of claim 1 wherein said software includes a security identification component that must be installed in native mode.

15. A system for automatically deploying software comprising:
a first tier comprising a PXE and NT authentication component and a deployment services server;
a second tier comprising SSL, Certificate and LDAP authentication communication to an intranet connecting to said first tier;
a third tier comprising SQL and NT authentication;
a fourth tier comprising MTS transaction integrity; and
a fifth tier comprising an SQL database and RDBMS Referential integrity and encryption.

16. A system for automatically deploying software comprising:
a scan process that collects detailed hardware configurations that are loaded in a relational database for the purpose of relating hardware configurations to operating system software configurations to determine which, if any, hardware is compatible with versions and configurations of an operating system;
a script engine at a target machine that initiates processes based on a batch input that is exported from a relational database at a deployment server;
a Visual Driver Manager that passes hardware peripheral, component and ASIC specific information to a script engine from a database for the purpose of generating a specific operating system configuration that will install a specific set of drivers specific to the target machine's hardware configuration at the time the OS installation or upgradeoccurs;
a Visual OS Manager Custom generation of Operating System installation or upgradesource trees that consolidate redundant files and identifies version and language unique files to permit multiple versions, languages and licensing models of an operating system to be installed from a single, unified source tree;
a Visual Package Manager that moves a native or ESD repacked software application installation package from a source file system to an operating system installation or upgrade source tree for the purpose of pushing a native or ESD installation package to a target during OS installation or upgrade;
a relational database that contains hardware and software configuration attributes specifically related for the purpose of generating operating system configuration parameters as xml messages or structured ascii text output files that can be interpreted by element 1 for the purpose of repeatable, custom operating system installations;

17. The system of claim 16 further comprising:
a client server application with a browser based GUI that permits a user to select microcomputer(s) and apply an operating system configuration ad-hoc or previously defined as a software configuration template.

18. The system of claim 16 further comprising:
an agent service that packages operating system configuration files and operating system files and executables for launching a specific deployment type and media and tracks deployment states using store and forward messaging to indicate operating system installation or upgrade progress milestones.

19. The system of claim 16 further comprising:
a Deployment Rollback manager that is Triggered during an operating system upgrade and uses an operating system client executed by PXE or floppy to restore operating system files required to successfully “restore” an operating system that existed prior to current installation or upgrade of OS.

20. An electronic data file, recorded or transmitted on a digital medium, that when loaded into an appropriately configured digital apparatus causes the apparatus to operate in accordance with the method of claim 1.

21. An electronic data file, recorded or transmitted on a digital medium, that when loaded into an appropriately configured digital apparatus causes the apparatus to embody the system of claim 15.

22. A method for executing a deployment at a target machine comprising:
utilizing a script engine to read input parameters defined as name value pairs, said input parameters generated by a server database application; and
at said script engine, initiating instructions causing installation or upgrade of a software system.

23. The method of claim 22 wherein said name value pairs may be customized by a user through a browser or client application interface.

24. The method of claim 22 wherein said installation or upgrade further comprises:
updating software preexisting on said target machine.

25. The method of claim 22 further comprising:
relating a specific hardware configuration to a specific software configuration in a relational database in a server;
generating parameterized files consisting of name/value pairs;
reading said parameterized files by a script engine;
setting environment variables or varibilized 1 parameters; and
building an installation file to be read by installation routines at a target machine.

26. A method of preparing for deployment of operating system or application software comprising:
collecting one or more detailed hardware configurations from target machines;
loading said configurations into a relational database; and
using said database for relating hardware configurations to operating system or application software configurations to determine which, if any, hardware is compatible with versions and configurations of an operating system.

27. The method of claim 26 wherein said collecting comprises at a target machine scanning configuration registers for the purpose of creating a machine specific hardware configuration in a structured file that can be bulk copied or read natively by a relational database.

28. The method of claim 26 wherein said collecting comprises retrieving vendor id, product id, product description, subsystem id and subsystem class for use as data keys in a relational database.

29. The method of claim 26 wherein said configuration registers includes one or more of PCI, PnP, SMB, DMI, USB, PCMCIA, CardBus, IEEE 1394, ATA, SCSI and Video BIOS registers.

30. The method of claim 27 further comprising:
parsing and interpret said configuration registers; and
formatting output that can be natively bulk copied into a relational database.

31. The method of claim 30 further comprising:
wherein said output is an xml message.

32. The method of claim 30 further comprising:
wherein said output is a structured ascii file.

33. A method of preparing for deployment of operating system or application software comprising:
collecting one or more detailed hardware configurations at target machines;
loading said configurations into a relational database; and
using said database for relating hardware configurations to operating system or application software configurations to determine which, if any, hardware is compatible with versions and configurations of an operating system.

34. The method of claim 33 further comprising:
adding driver support to an OS source tree by parsing third party driver OS information files to identify the binaries, installation definitions and adding them to an operating system source tree.

35. The method of claim 34 further comprising:
tracking specific drivers, versions, and compatibilities from said source tree in a source tree in said database.

36. The method of claim 34 further comprising:
using a graphical user interface, on can assert a source device, whereby the drivers are uploaded to a specific directory that can be tracked in said database.

37. The method of claim 33 further comprising:
optionally editing the original installation file and merging it with the source tree in such a way as to enable the operating systems hardware detection facility to install the device by automatic detection or by explicitly defining the hardware in an information file that the operating system reads during OS installation.

38. The method of claim 33 further comprising:
retrieving vendor id, product id, product description, subsystem id and subsystem class for use as data keys in a relational database, said data keys used as parameters for installation flags for one or more system components requiring direct, version specific, hardware driver support.

39. A method of custom generation of operating system (OS) installation source trees comprising:
consolidating redundant files;
identifying version and language unique files thus permitting multiple versions, languages and licensing models of an operating system to be installed from a single, unified source tree;
retrieving CD-ROM volume and serial number and create database records of OS version, type & language;
wherein said information is retrieved from a form a user completes that is posted to a database table;
wherein a primary key in this table will be a PID read from a CD;
providing an interface allowing an end user to override detected Operating System and Language;
prompting a user to select the appropriate Operating system license model;
prompting a user to delete uploaded CDs;
prompting a user if there is an attempt to upload same CD-ROM more than once;
assigning each operating system a unique ID code, said code be used to determine the OS combinations.

40. The method of claim 39 further comprising:
moving a native or ESD repacked software application installation package from a source file system to an operating system installation source tree for pushing a native or ESD installation package to a target during OS installation;
using generic “forms” in the front end and tables in the database that permit a user to enter the name, source path and installation parameters of a software installation package or ESD client.
writing OS and ESD configuration to parameter files for passing the OS configuration and “ESD packages” to be installed on a target machine to a script engine which will then copy a custom “set” of packages per installation.

41. The method of claim 39 further comprising:
providing a multi-cast publishing services to multi-cast client subscribers; wherein the agent interacts with the database for authentication of subscribers and configuration of file sets of subscriber sessions; and
during OS installation, a “multi-cast” client is installed and optionally executed on the target PC that “reads” the installation parameter file and subscribes to a file based multi-cast session after the operating system is running in GUI mode and has authenticated to the Deployment Agent.

42. A method of operating a deployment database holding hardware and software configuration attributes specifically related for the purpose of generating operating system configuration parameters for the purpose of repeatable, custom operating system installations comprising:
create database tables to represent entities for managing deployment;
creating database tables to represent parameters and values of an operating systems installation facility to include elements of an operating system source tree required to perform an installation of a specific language, version, and license model;
creating database tables to represent operating system and application license keys per configuration;
relating one or many hardware configurations to one or many operating system configurations;
relating processes to customers by demographics and network directories so that elements can be selected using customers, sites, departments and networks as operating system configuration selection criterion.

43. The method of claim 42 further comprising:
including a data import facility to import files created by scanning in target machines.

44. The method of claim 42 further comprising:
including a data export facility to export parameter files or messages for a script engine at a target machine.

45. A client/server application with a browser based GUI that permits a user to select microcomputer(s) and apply an operating system configuration comprising:
a secure client interface that accesses a database for the purpose of providing a simple to use interface that enables a non-technical user to create complex, repeatable operating system configurations for deployment to target machines;
an administrative console that allows a network administrator to demographically model the deployment database to resemble the domain or directory objects;
a hardware configuration form that allows a user to view the target machines hardware configuration, OS compatibility and optionally choose what components are to have drivers support installed.
a hardware configuration form that allows a user to designate a machine or components of a machine as compatible with a specific OS version and patch level.
a software configuration form that allows a user to define and choose and configure an operating system installation by language, license model, version and patch level.
a software and system configuration management form that allows a user to generically define packages or utilities to be pushed to a target machine during operating system installation. and
a form that permits users to move machines between customers, sites and departments to reflect physical moves.

46. The application according to claim 45 further comprising:
wherein said domain or directory objects comprise customers, sites, departments and deployment servers.

47. The application according to claim 45 further comprising:
an interface that allows ASP and customers to collaborate on deployment projects.

48. The application according to claim 45 further comprising:
user id deployment roles that constrain user privileges by demograhics and administrative capabilities.

49. The application according to claim 45 further comprising:
a multi-language browser translation facility that permits users to view the application in their preferred language.

50. The application according to claim 45 further comprising:
wherein said browser application is an N-Tier DNA application.

51. A deployment manager agent service that packages operating system configuration files and operating system files and executables for launching a specific deployment type and media wherein said agent service tracks deployment states using store and forward messaging to indicate operating system installation progress milestones and further comprising:
a PXE that delivers and executes operating system deployments using a pre-boot execution environment for specific target machines by identifying hardware elements which represent data keys for parameter files delivered to a PXE server by a service agent.

52. The agent service according to claim 51 further wherein a 16 bit OS delivers and executes operating system deployments using a 16 bit operating system client for specific target machines by identifying hardware elements which represent data keys for parameter files delivered to a bootable media by a service agent.

53. The agent service according to claim 51 further wherein a 32 bit OS delivers and executes operating system deployments using a 32 bit operating system client for specific target machines by identifying hardware elements which represent data keys for parameter files delivered to a bootable media by a service agent.

54. The agent service according to claim 51 further wherein a 64 bit OS delivers and executes operating system deployments using a 64 bit operating system client for specific target machines by identifying hardware elements which represent data keys for parameter files delivered to a bootable media by a service agent.

55. The agent service according to claim 51 further comprising a Wake On Lan triggering operating system deployments using a wake on Lan calls for specific target machines by identifying hardware elements which represent data keys for parameter scripts delivered to a bootable media by a service agent.

56. The agent service according to claim 51 further comprising scheduling a cron-like facility that submits deployment configurations based on a user defined calendar.

57. A method of providing for a deployment rollback comprising:
triggering, during an operating system upgrade, a deployment rollback process;
said process using an operating system client executed by PXE or floppy to restore operating system files required to successfully “restore” the 16, 32 or 64 bit operating system that existed prior to installation of a new operating system;
verifying that disk and partition space meet rollback requirements for each target PC.
performing backup on a system root directory of the operating system targeted for upgrade storing the files on a local or network file system;
performing backup on a registry of the operating system targeted for upgrade storing the files on a local or network file system;
performing backup on an OS installation source directory (if present) of the operating system targeted for upgrade storing the files on a local or network file system;
performing backup on a DM install directory (if present) of the operating system targeted for upgrade storing the files on a local or network file system;
performing backup on a Windows OS directory of the operating system targeted for upgrade storing the files on a local or network file system;
performing backup on a MBR, boot sector and file allocation tables of the of the operating system targeted for upgrade storing the files on a local or network file system; and
performing backup on user specified files and/or directories of the operating system targeted for upgrade restore.

58. The method of claim 57 further comprising:
restoring the Windows OS directory of the operating system targeted for upgrade reading the specific target's files from a local or network file system;
restoring the registry of the operating system targeted for upgrade reading the specific target's files from a local or network file system;
restoring the system root directory of the operating system targeted for upgrade reading the specific target's files from a local or network file system;
restoring the OS installation source directory (if present) of the operating system targeted for upgrade reading the specific target's storing the files on a local or network file system;
restoring MBR, boot sector and file allocation tables of the of the operating system targeted for upgrade storing the files on a local or network file system;
restoring the DM install directory (if present) of the operating system targeted for upgrade reading specific target's files from a local or network file system; and
restoring backup on user specified files and/or directories of the operating system targeted for upgrade restore.
